(19) United States
(12) Patent Application Publication
(10) Pub. No.: US 2026/0005560 A1
(43) Pub. Date: Jan. 1, 2026

(54) WOUND ROTOR AND WOUND ROTOR ASSEMBLY THAT CAN GENERATE SUPERIMPOSED MAGNETIC FIELD IN THE SAME DIRECTION

(71) Applicant: TECO Electric & Machinery Co., Ltd., TAIPEI CITY (TW)

(72) Inventors: Shin FANN, TAIPEI CITY (TW); Lian-Shin HUNG, TAIPEI CITY (TW); Ming-Te HO, TAIPEI CITY (TW); Ching-Chih HUANG, TAIPEI CITY (TW)

(21) Appl. No.: 19/186,992

(22) Filed: Apr. 23, 2025

(30) Foreign Application Priority Data
Jun. 27, 2024 (TW) 113124024

(51) Int. Cl. H02K 1/22; H02K 1/278; H02K 13/00

(52) U.S. Cl. CPC H02K 1/223; H02K 1/278; H02K 13/003

(57) ABSTRACT

A wound rotor assembly is capable of generating a superimposed magnetic field in the same direction, and includes a shaft and a wound rotor that generates the superimposed magnetic field. The wound rotor includes a rotor core, multiple magnets, and several coil windings. The rotor core includes a yoke portion, several tooth portions, and several shoe portions. The yoke portion is fitted onto the shaft. The tooth portions are extended outwardly and radially from the yoke. The shoe portions are formed at the opposite ends of the tooth portions relative to the yoke portion. The magnets are fixed to the shoe portions to generate a basic magnetic field when the rotor core rotates. The coil windings are fitted onto the tooth portions to receive control power and generate the superimposed magnetic field in the same direction as the basic magnetic field when an intensity of the basic magnetic field does not reach to the required magnetic field intensity.

This application claims the benefit of Taiwan Patent Application Serial No. 113124024, filed on Jun. 27, 2024, the subject matter of which is incorporated herein by reference.

### BACKGROUND OF THE INVENTION

### (1) Field of the Invention

The invention relates to a rotor, and more particularly to a wound rotor capable of generating a superimposed magnetic field in the same direction.

### (2) Description of the Prior Art

In general, permanent magnet motors must meet the requirements of both high torque at low speed and low torque at high speed in some application requirements, such as automotive motor specifications. In order to meet these two extreme specifications, the selection of magnet must have both high magnetic energy product and high magnetic field intensity to correspond to the control matching of the drive.

When an automotive motor uses a magnet with a high magnetic energy product, it can generate high torque at low speed through the control matching of the drive, thereby achieving the characteristic of high output. However, under high-speed operating conditions, the magnetic energy product of the magnet will be too strong, causing the motor's power generation to be higher than the input voltage. At this time, the drive must be used for magnetic weakening control (i.e., reverse magnetic field) to reduce the magnetic energy product of the magnet. However, since the magnet itself must have the characteristic of high resistance to reverse magnetic field, hence, the greater the difference in rotating speed between high torque at low speed and low torque at high speed, the higher the selected magnet specifications will be, resulting in a relatively higher cost for the automotive motor.

### SUMMARY OF THE INVENTION

In view of the fact that in the prior arts, in order to meet the requirements of high torque at low speed and low torque at high speed, the present automotive motors usually use magnets with high magnetic energy product. Magnet with high magnetic energy product can smoothly generate high torque when running at low speed. However, when low torque at high speed is required, magnetic weakening control is required through the drive to prevent the motor's power generation from being higher than the input voltage. Therefore, the magnet used need to have high resistance to reverse magnetic field, which results in high cost for the automotive motor due to the selection of high-specification magnet. Hence, the main purpose of the present invention is to provide a wound rotor that can easily adjust the magnetic field's intensity through the cooperation of magnets and coil windings.

To solve the problems of the prior art, the necessary technical means adopted by the present invention is to provide a wound rotor, which is capable of generating a superimposed magnetic field in the same direction, and comprises a rotor core, a plurality of magnets and a plurality of coil windings.

The rotor core includes a yoke portion, a plurality of tooth portions and a plurality of shoe portions. The yoke portion is fitted onto a shaft. The plurality of tooth portions are respectively extended outwardly and radially from the yoke portion. The plurality of shoe portions are respectively formed at opposite ends of the tooth portions relative to the yoke portion.

The plurality of magnets are respectively fixed to the shoe portions to generate a basic magnetic field when the rotor core rotates.

The plurality of coil windings are respectively fitted onto the tooth portions to receive a control power and generate the superimposed magnetic field in the same direction which superimposed on the basic magnetic field when an intensity of the basic magnetic field does not reach to a required magnetic field intensity.

Among the ancillary technical means derived from the above necessary technical means, the plurality of magnets include a plurality of first magnets and a plurality of second magnets, and the first magnets and the second magnets are arranged in a staggered manner on the shoe portions.

Another necessary technical means adopted in the present invention is to provide a wound rotor assembly, which is capable of generating a superimposed magnetic field in the same direction, and comprises a shaft and a wound rotor capable of generating the superimposed magnetic field in the same direction.

The wound rotor capable of generating the superimposed magnetic field in the same direction includes a rotor core, a plurality of magnets and a plurality of coil windings.

The rotor core includes a yoke portion, a plurality of tooth portions and a plurality of shoe portions. The yoke portion is fitted onto the shaft. The plurality of tooth portions are respectively extended outwardly and radially from the yoke portion. The plurality of shoe portions are respectively formed at opposite ends of the tooth portions relative to the yoke portion.

The plurality of magnets are respectively fixed to the shoe portions to generate a basic magnetic field when the rotor core rotates.

The plurality of coil windings are respectively fitted onto the tooth portions to receive a control power and generate the superimposed magnetic field in the same direction which superimposed on the basic magnetic field when an intensity of the basic magnetic field does not reach to a required magnetic field intensity.

Among the ancillary technical means derived from the above necessary technical means, the plurality of magnets include a plurality of first magnets and a plurality of second magnets, and the first magnets and the second magnets are arranged in a staggered manner on the shoe portions.

Preferably, the shaft is extended from a first end to a second end, and the yoke portion is fixed between the first end and the second end. Additionally, the first end is further provided with two slip rings, and the coil windings are electrically connected to the slip rings respectively.

As mentioned above, the present invention mainly fixes the magnets to the shoe portion of the rotor core and sets the coil windings on the tooth portion of the rotor core. Thus, the user can selectively energize the coil windings to increase the magnetic field's intensity according to the usage requirements, thereby using magnets of lower specifications and effectively reducing the overall cost.

The specific embodiments used in the present invention will be further explained through the following embodiments and drawings.

### BRIEF DESCRIPTION OF THE DRAWINGS

The present invention will now be specified with reference to its preferred embodiment illustrated in the drawings, in which:

FIG. 1 is a three-dimensional schematic diagram showing a wound rotor assembly capable of generating a superimposed magnetic field in the same direction provided by a preferred embodiment of the present invention;

FIG. 2 is a partially exploded perspective view of a wound rotor assembly capable of generating a superimposed magnetic field in the same direction provided by a preferred embodiment of the present invention;

FIG. 3 is a schematic diagram of the A-A section of FIG. 1;

FIG. 4 is a cross-sectional diagram showing the basic magnetic field generated by magnets; and

FIG. 5 is a cross-sectional diagram showing the coil windings generating the superimposed magnetic field in the same direction.

### DESCRIPTION OF THE PREFERRED EMBODIMENT

The invention disclosed herein is directed to a wound rotor and a wound rotor assembly capable of generating a superimposed magnetic field in the same direction. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

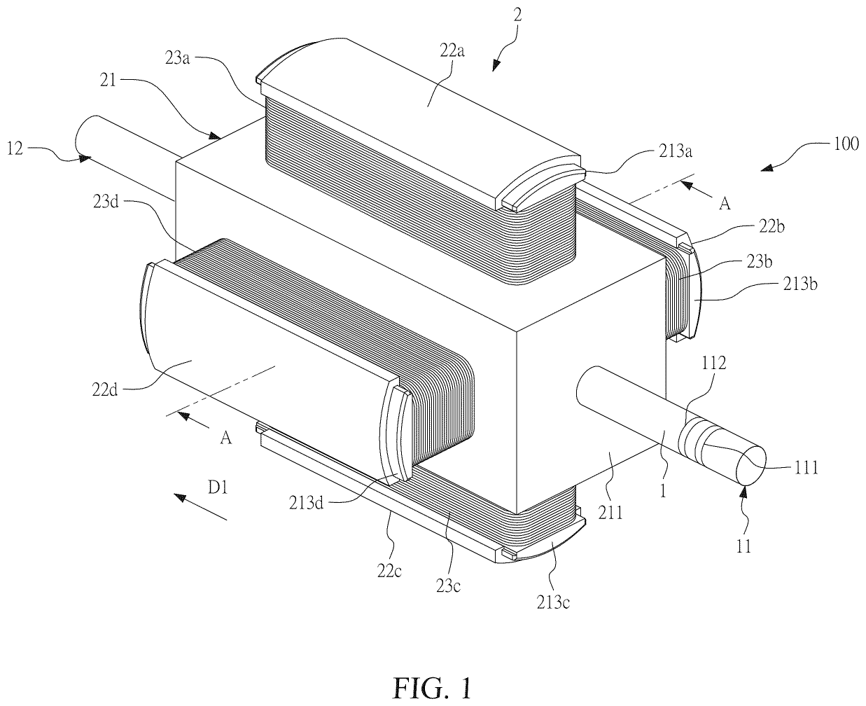

Referring to FIG. 1, FIG. 1 is a three-dimensional schematic diagram showing a wound rotor assembly capable of generating a superimposed magnetic field in the same direction provided by a preferred embodiment of the present invention. As shown in FIG. 1, a wound rotor assembly 100 is capable of generating a superimposed magnetic field in the same direction, and comprises a shaft 1 and a wound rotor 2. The shaft 1 is extended from a first end 11 to a second end 12 along an axial direction D1, and the first end 11 is further provided with two slip rings 111 and 112, so that the positive and negative brushes can electrically contact the slip rings 111 and 112 in actual use.

The wound rotor 2 is capable of generating the superimposed magnetic field in the same direction, and includes a rotor core 21, four magnets 22a, 22b, 22c and 22d and four coil windings 23a, 23b, 23c and 23d.

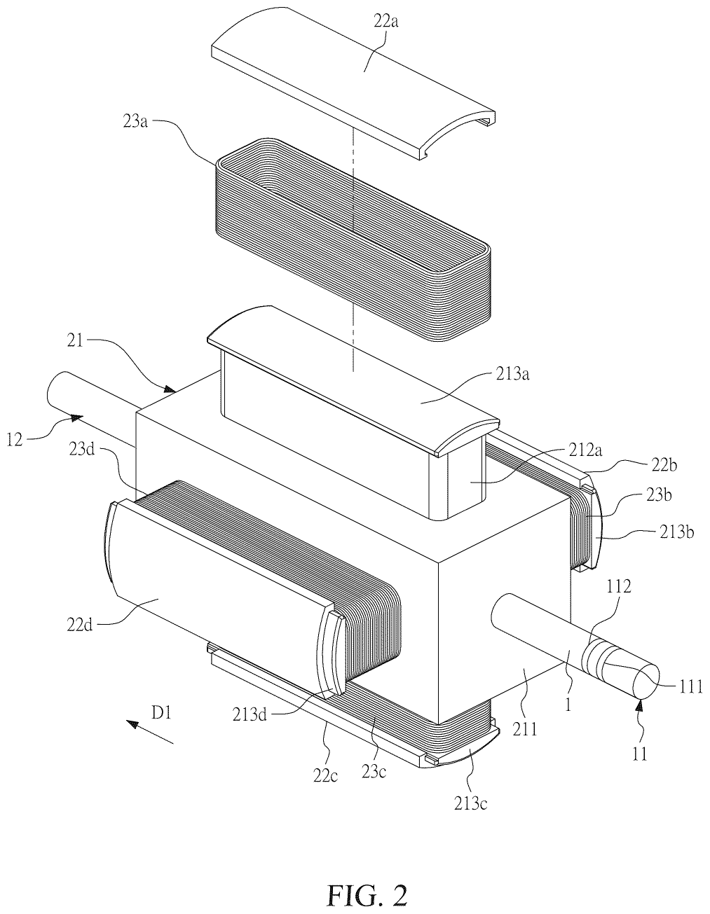

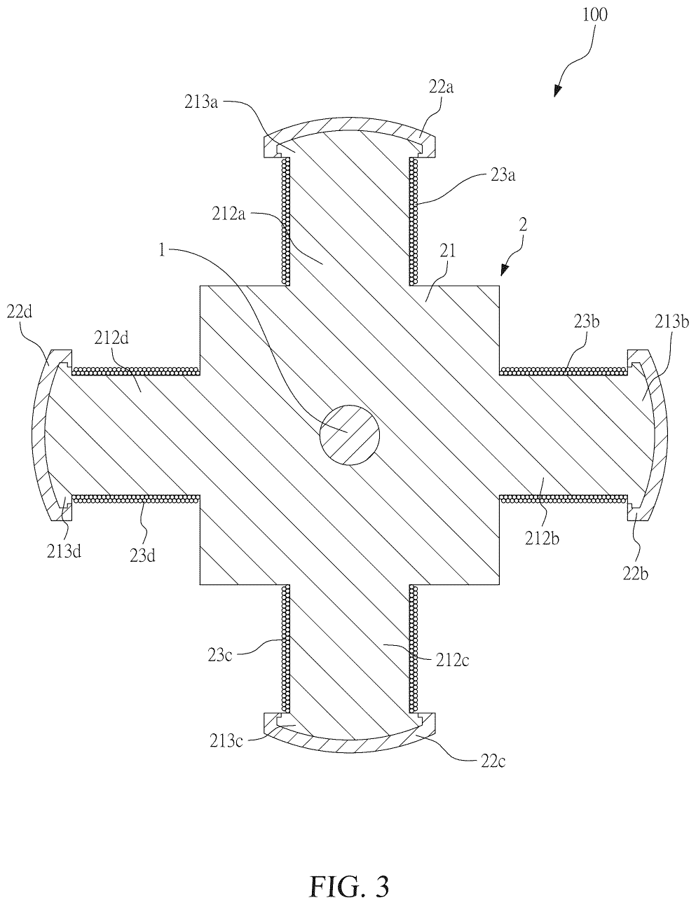

Referring now to FIG. 2 and FIG. 3, FIG. 2 is a partially exploded perspective view of a wound rotor assembly capable of generating a superimposed magnetic field in the same direction provided by a preferred embodiment of the present invention; FIG. 3 is a schematic diagram of the A-A section of FIG. 1. As shown in FIG. 1 to FIG. 3, The rotor core 2 includes a yoke portion 211, four tooth portions 212a, 212b, 212c and 212d and four shoe portions 213a, 213b, 213c and 213d. The yoke portion 211 is fitted onto the shaft 1 and located between the first end 11 and the second end 12.

Four tooth portions 212a, 212b, 212c and 212d are respectively extended outwardly and radially from the yoke portion 211. Since the yoke portion 211 of the present embodiment is a square column and the rotor core 21 includes four tooth portions 212a, 212b, 212c and 212d, hence, the four tooth portions 212a, 212b, 212c and 212d are integrally formed and protrude from the four sides of the yoke portion 211, and the extension directions of any two adjacent tooth portions 212a, 212b, 212c and 212d are perpendicular to each other. That is, the 360 degrees around the yoke portion 211 are divided into four equal parts. However, in other embodiments, it is not limited to this. In practice, the tooth portions can be evenly distributed according to the number of tooth portions (illustrated in other embodiments).

Four shoe portions 213a, 213b, 213c and 213d are respectively formed at opposite ends of the tooth portions 212a, 212b, 212c and 212d relative to the yoke portion 211. The four shoe portions 213a, 213b, 213c and 213d of the present embodiment are respectively connected to the four tooth portions 212a, 212b, 212c and 212d in an integral manner. In addition, the rotor core 21 is formed, in practice, by stacking a plurality of silicon steel sheets, for example.

The magnets 22a, 22b, 22c and 22d are respectively fixed to the shoe portions 213a, 213b, 213c and 213d, wherein the magnets 22a and 22c are first magnets, and the magnets 22b and 22d are second magnets. The first magnets and the second magnets are arranged in a staggered manner, and the difference between the first magnets and the second magnets is that the directions of the magnetic fields are opposite. In addition, taking the magnet 22a as an example, the magnet 22a is fixed to the shoe portion 213a by a locking method, for example.

The coil windings 23a, 23b, 23c and 23d are respectively fitted onto the tooth portions 212a, 212b, 212c and 212d to electrically connect to the slip rings 111 and 112 respectively.

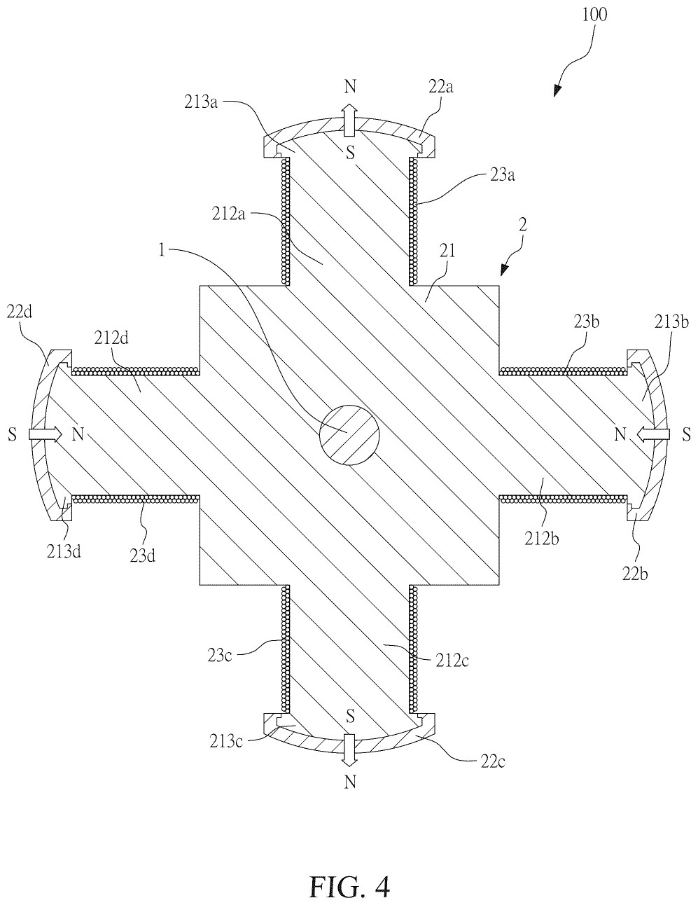

Referring now to FIG. 4, FIG. 4 is a cross-sectional diagram showing the basic magnetic field generated by magnets. As shown in FIG. 1 to FIG. 4, in the present embodiment, the magnetic field directions of the magnets 22a and 22c are from the inner S pole toward the outer N pole, while the magnetic field directions of the magnets 22b and 22d are from the outer S pole toward the inner N pole; thereby, when the rotor core 21 rotates, a basic magnetic field is generated (not shown in the figures, that is, the circular magnetic field is generated when the magnets 22a, 22b, 22c and 22d move around).

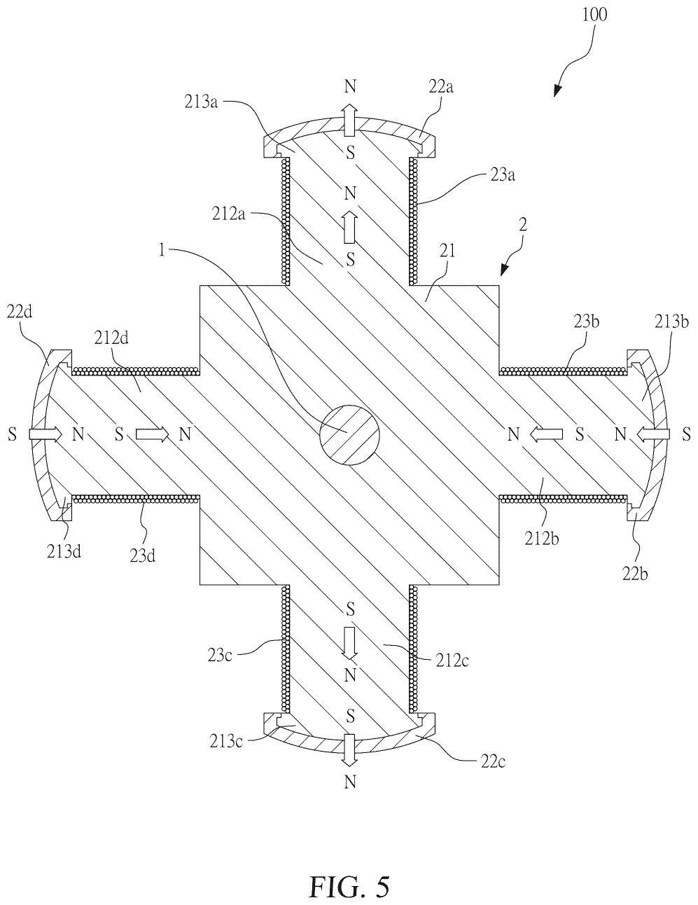

Referring now to FIG. 5, FIG. 5 is a cross-sectional diagram showing the coil windings generating the superimposed magnetic field in the same direction. As shown in FIG. 1 to FIG. 5, coil windings 23a, 23b, 23c and 23d receive a control power and generate the superimposed magnetic field in the same direction which superimposed on the above basic magnetic field when an intensity of the basic magnetic field does not reach to a required magnetic field intensity (not shown in the figures, that is, the circular magnetic field is generated when the coil windings 23a, 23b, 23c and 23d move around).

As mentioned above, the magnetic field directions of the coil windings 23a and 23c is the same as that of the magnets 22a and 22c, both from the outer S pole to the inner N pole, and the magnetic field directions of the coil windings 23b and 23d is the same as that of the magnets 22b and 22d, both from the inner S pole to the outer N pole. Among these, when the winding methods of the coil windings 23a, 23b, 23c and 23d are the same, the reason why the magnetic field directions of the coil windings 23a and 23c and those of the coil windings 23b and 23d are different is mainly because the two ends of the coil windings 23a and 23c and the two ends of the coil windings 23b and 23d are connected to the power supply in opposite ways. For example, the ends of the coil windings 23a and 23c adjacent to the first end 11 are both electrically connected to the slip ring 111, and the ends of the coil windings 23a and 23c adjacent to the second end 12 are both electrically connected to the slip ring 112. On the contrary, the ends of the coil windings 23b and 23d adjacent to the first end 11 are both electrically connected to the slip ring 112, and the ends of the coil windings 23b and 23d adjacent to the second end 12 are both electrically connected to the slip ring 111, thereby making the magnetic field directions of the coil windings 23a and 23c and the coil windings 23b and 23d different. Since it is common knowledge in the art that a coil generates a magnetic field when it is energized, it will not be described in detail here.

As mentioned above, when existing permanent magnet motors are used as automotive motors, in order to achieve the requirements of high torque at low speed and low torque at high speed, it is often necessary to select high-specification magnets with high magnetic energy product. Only through such high-specification magnets can generate high torque at low speed. Then, at high speed, the magnetic weakening control of the drive is used to prevent the permanent magnet motor's power generation from being higher than the input voltage. In comparison, since wound rotor assembly capable of generating a superimposed magnetic field in the same direction, comprising a shaft and a wound rotor capable of generating the superimposed magnetic field in the same direction of the present invention is provided with magnets on the shoe portions of the rotor core and coil windings on the tooth portions, the basic magnetic field can be provided by the magnets. When an intensity of the basic magnetic field does not reach to the required magnetic field intensity, the coil windings are powered to generate a superimposed magnetic field in the same direction superimposed on the basic magnetic field. In this way, the magnetic field intensity can be easily adjusted through a simple structure, resulting in the use of magnets with lower specifications, effectively reducing the overall manufacturing cost. In addition, compared to the prior art, when using a drive for magnetic weakening control, the magnet is easily demagnetized due to the influence of anti-magnetism. Since the present invention generates a basic magnetic field through magnets and provides a superimposed magnetic field superimposed on the basic magnetic field through coil windings when needed, the present invention can effectively avoid the problem of magnet demagnetization.

While the present invention has been particularly shown and described with reference to a preferred embodiment, it will be understood by those skilled in the art that various changes in form and detail may be without departing from the spirit and scope of the present invention.

What is claimed is:

1. A wound rotor, being capable of generating a superimposed magnetic field in the same direction, and comprising:
a rotor core, including;
a yoke portion, fitted onto a shaft;
a plurality of tooth portions, respectively extended outwardly and radially from the yoke portion; and
a plurality of shoe portions, respectively formed at opposite ends of the tooth portions relative to the yoke portion;
a plurality of magnets, respectively fixed to the shoe portions to generate a basic magnetic field when the rotor core rotates; and
a plurality of coil windings, respectively fitted onto the tooth portions to receive a control power and generate the superimposed magnetic field in the same direction which superimposed on the basic magnetic field when an intensity of the basic magnetic field does not reach to a required magnetic field intensity.

2. The wound rotor of claim 1, wherein the plurality of magnets include a plurality of first magnets and a plurality of second magnets with opposite magnetic field directions, and the first magnets and the second magnets are arranged in a staggered manner on the shoe portions.

3. A wound rotor assembly, being capable of generating a superimposed magnetic field in the same direction, and comprising:
a shaft; and
a wound rotor capable of generating the superimposed magnetic field in the same direction, including:
a rotor core, including:
a yoke portion, fitted onto the shaft;
a plurality of tooth portions, respectively extended and radially outwardly from the yoke portion and
a plurality of shoe portions, respectively formed at opposite ends of the tooth portions relative to the yoke portion;
a plurality of magnets, respectively fixed to the shoe portions to generate a basic magnetic field when the rotor core rotates; and
a plurality of coil windings, respectively fitted onto the tooth portions to receive a control power and generate the superimposed magnetic field in the same direction which superimposed on the basic magnetic field when an intensity of the basic magnetic field does not reach to a required magnetic field intensity.

4. The wound rotor assembly of claim 3, wherein the plurality of magnets include a plurality of first magnets and a plurality of second magnets with opposite magnetic field directions, and the first magnets and the second magnets are arranged in a staggered manner on the shoe portions.

5. The wound rotor assembly of claim 3, wherein the shaft is extended from a first end to a second end, and the yoke portion is fixed between the first end and the second end.

6. The wound rotor assembly of claim 5, wherein the first end is further provided with two slip rings, and the coil windings are electrically connected to the slip rings respectively.
